(19) United States
(12) Patent Application Publication
(10) Pub. No.: US 2009/0314717 A1
(43) Pub. Date: Dec. 24, 2009

(54) OIL-ADSORBING PARTICLE COMPOSITE AND WATER-TREATMENT METHOD USING THE SAME

(75) Inventors: Shinetsu Fujieda, Kanagawa-ken (JP); Tatsuoki Kohno, Tokyo (JP); Shinji Murai, Kanagawa-ken (JP); Taro Fukaya, Kanagawa-ken (JP); Hideyuki Tsuji, Kanagawa-ken (JP); Akiko Suzuki, Tokyo (JP); Nobuyuki Ashikaga, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/490,680

(22) Filed: Jun. 24, 2009

(30) Foreign Application Priority Data
Jun. 24, 2008 (JP) 2008-164067

(51) Int. Cl. C02F 1/28; H01F 1/00

(52) U.S. Cl. 210/663; 252/62.51 R

(57) ABSTRACT

An oil-adsorbing particle composite and a water-treatment method using the same are provided. The particle composite is capable of selectively adsorbing contaminants such as oils contained in industrial and household wastewaters. The water-treatment method is capable of eliminating contaminants from the wastewater using the composite. The particle composite includes water-insoluble organic polymer particles, magnetic particles and a resin binder, the resin binder bonding the polymer particles and the magnetic particles. The polymer particles have an oil-adsorbing characteristic. The magnetic particles have a magnetic characteristic for a rapid collection of the composite using magnetic forces. The method includes dispersing the particle composite in contaminant-containing water, making the particle composite adsorb contaminants to separate the particle composite from the water after the adsorbing.

### CROSS REFERENCE TO RELATED APPLICATION

This application is based upon and claims the benefit of priority from the prior Japanese Patent Application No. 2008-164067, filed on Jun. 24, 2008, the entire contents of which are incorporated herein by reference.

### FIELD OF THE INVENTION

The present invention relates to an oil-adsorbing particle composite, capable of selectively adsorbing contaminants contained in industrial and household wastewaters or oils which outflow to rivers or seas, and a water-treatment method of eliminating the contaminants from the wastewaters, etc. using the composite.

### DESCRIPTION OF THE BACKGROUND

A wastewater is discharged from factories, restaurants, common residences, etc. The wastewater contains contaminants, particularly mineral oils, or vegetal oils in many cases. Outflows of wastewaters to rivers and seas cause environmental pollutions, having been a serious problem. Oils flowed out to rivers and seas in large amounts are normally collected using an oil fence to be removed, the oil fence preventing spread of the oils. Furthermore, oils are solidified by an oil-gelling agent etc. to be collected according to one of oil-collecting methods. However, solidification of oils is difficult for fast-flowing rivers or stormy seas. In such a case, oils having not been solidified are washed ashore on a beach to influence sea birds or marine resources significantly. Particularly the influence on living things of the periphery was great, and the influence on an ecosystem was unfathomable. On the other hand, in wastewater-treatment facilities of which targets are a small amount of oils diffused in water, it is common to use a filter for the oil removal. However, in such a method, clogging of the filter occurs frequently due to the oils contained in the wastewater. Consequently, there has been a problem that it is time-consuming and expensive to maintain a wastewater-treatment apparatus, e.g., to replace a filter. Moreover, when oil mixes so much in wastewater, the oil may dissociate from the water to float on the wastewater surface. In such a case, filtering the oils as they are clogs the filters in the apparatus immediately. Thus, dispersing organic oil-adsorbent made of oleophilic polymers or inorganic adsorbent such as silica, pearlite etc. are needed, and is followed by filtering, thus making the water treatment complicated. It remains a problem that the organic adsorbent is difficult to collect after spreading and oils are also difficult to treat even if collected.

Various trials are conducted in order to solve the problem resulting from such adsorbent. As an adsorbing method of oils in water, there is known a method in which an oil-adsorbing polymer with hydrophilic and oleophilic blocks are used to adsorb the oils and then the polymer having adsorbed the oils is removed from the water. Such a polymer is disclosed by Japanese laid-open patent application JP-A 1995-102238 (Kokai). However, the method has a problem that not only separating the oil-adsorbing polymer from water is troublesome, but also workability of the polymer is low due to softening of the polymer having adsorbed oils.

On the other hand, there is also known a method of magnetically separating magnetic adsorbent-particles having adsorbed oils. For example, JP-A 2000-176306 (Kokai) discloses a method in which surfaces of magnetic particles are modified with stearic acid to make the particles adsorb underwater oils for collecting the oils. However, this method also has a problem that low molecular compounds such as stearic acid and a coupling agent adversely contaminate water due to the use of the acid and agent for the surface modifications of the magnetic particles.

### SUMMARY OF THE INVENTION

An object of the invention is to provide an oil-adsorbing particle composite and a water-treatment method using the same. The particle composite is capable of selectively adsorbing contaminants contained in industrial and household wastewaters or oils which outflow to rivers or seas. The water-treatment method is capable of eliminating the contaminants from the wastewaters using the particle composite.

To achieve the above object and according to one aspect of the invention, an oil-adsorbing particle composite are provided. The particle composite includes water-insoluble organic polymer particles, magnetic particles and a resin binder, the resin binder bonding the polymer particles and the magnetic particles. The polymer particles have an oil-adsorbing characteristic. The magnetic particles have a function for a rapid collection using a magnet.

To achieve the above object and according to other aspect of the invention, a water-treatment method is provided. The method includes dispersing the particle composite in contaminant-containing water, making the particle composite adsorb the contaminants to separate the particle composite from the water after the adsorbing.

### BRIEF DESCRIPTION OF DRAWINGS

The accompanying drawings, which are incorporated in and constitute a part of this specification, illustrate embodiments of the invention and together with the description, serve to explain the principles of the invention.

FIG. 1 shows a schematic sectional view of an apparatus for a small-scale water treatment using an oil-adsorbing particle composite according to the invention.

FIG. 2 shows a schematic sectional view of an apparatus for a large-scale water treatment using an oil-adsorbing particle composite according to the invention.

### DETAILED DESCRIPTION OF THE INVENTION

### Oil-Adsorbing Particle Composite

An oil-adsorbing particle composite for a water treatment according to the invention includes water-insoluble polymer particles, magnetic particles and a resin binder, the polymer particles and the magnetic particles being bonded with the resin binder. The polymer particles provide the composite with an oil-adsorbing characteristic, and the magnetic particles provide the composite with an easy collection of the composite in an adsorption-separation process.

A polymer which constitutes the water-insoluble organic polymer particles primarily has an oil-adsorbing characteristic of the particles in the invention. An organic polymer generally has a hydrocarbon chain, the chain showing oleophilicity, i.e., the oil-adsorbing characteristic. However, in order to adsorb oils efficiently, highly oleophilic polymer is preferable. Such a highly oleophilic polymer can be obtained by polymerizing monomers with unsaturated bonds. Furthermore, the organic polymer needs to maintain solid form in water and to be water-insoluble in the invention.

Homopolymer or copolymer synthesized from at least one kind of the following monomers is referred to as an example of the preferable polymer. The monomers are selected from monomers with a polymerizable unsaturated bond, e.g., an unsaturated hydrocarbon monomer unit, a (meta)acrylic acid monomer and derivatives of these. In addition, hereinafter, acrylic acid and meta-acrylic acid are referred to as (meta)acrylic acid for simplicity.

Unsaturated hydrocarbon monomers include styrene, isoprene, butadiene, ethylene, p-methylstyrene, alpha-methylstyrene, etc. (Meta)acrylic acid monomers include acrylic acid, methacrylic acid, ethyl acrylate, n-butyl acrylate, isobutyl acrylate, acrylic acid 2-ethyl hexyl, n-butyl methacrylate, methacrylic acid 2-ethyl hexyl, methyl acrylate, methyl methacrylate, ethyl methacrylate, methacrylic acid isobutyl, cyclohexyl methacrylate, benzyl methacrylate, isobornyl methacrylate, methacrylic acid 2-hydroxyethyl, methacrylic acid 2-methoxyethyl, glycidyl methacrylate, methacrylic acid tetrahydrofurfuryl, diethylaminoethyl methacrylate, methacrylic acid trifluoroethyl, and methacrylic acid heptadecafluorodecyl, etc.

The monomers with these polymerizable unsaturated bonds can be used independently or by combining two or more of these. In addition, it is also possible to use together with other copolymerizable monomers, unless the performance of the polymer particles thus obtained goes down. Acetic acid vinyl is referred to as an example of the copolymerizable monomer.

More specifically, the polymers obtained by polymerizing monomers include (a) polystyrene, hydrogenated polystyrene, polyisoprene, polybutadiene, polyethylene, each homopolymer of polyacrylic acid, (b) copolymer having a structure of the homopolymer as a block, e.g., block copolymer having a block of polystyrene or hydrogenated polystyrene as a structure chain, (c) copolymer randomly containing comonomers such as butadiene-styrene copolymer, acrylonitrile-butadiene-styrene copolymer, acrylonitrile-chlorinated polyethylene-styrene copolymer, acrylonitrile-styrene copolymer, acrylonitrile-styrene-acrylic rubber copolymer, methyl methacrylate-butadiene-styrene copolymer body, styrene-butadiene-isoprene copolymer, styrene-butadiene-ethylene copolymer, hydrogenated styrene-isoprene-butadiene copolymer, etc. A molecular weight of these polymers is not limited in particular. However, it is preferable that a weight-average molecular weight of the oil-adsorbing particle composite including these polymers is 1×10⁴ or more, and is particularly 1×10⁵ or more in order to strengthen the particle composite.

The water-insoluble organic polymer particles in the particle composite preferably have a porous structure to perform oil-adsorption in the invention. Such a porous structure allows it to increase surface area of the particles, consequently improving an oil-adsorbing capability. In order to provide the polymer particles with porous structures, crosslinkable monomers are preferably employed as raw materials. Crosslinkable monomers are not limited particularly only if they have two or more polymerizable groups. The crosslinkable monomers include acrylicacidester-series-monomers such as ethylene glycoldi(meta)acrylate, diethyleneglycoldi(meta)acrylate, triethyleneglycol di(meta)acrylate, decaethylene glycoldi(meta)acrylate, pentadecaethylene glycoldi(meta)acrylate, 1,3-butyleneglycoldi(meta)acrylate, 1,4-butanedioldi(meta)acrylate, 1,6-hexanedioldi(meta)acrylate, glycerindi(meta)acrylate, trimethylolpropantri(meta)acrylate, pentaerythritoltetra(meta)acrylate, phthalatediethylene glycoldi(meta) acrylate, caprolactone-modified-dipentaerythritolhexa(meta)acrylate, caprolactone-modified-neopentylglycolhydroxypivalatediacrylate, polyesteracrylate, urethanacrylate, etc. The crosslinkable monomers also include divinylbenzene, divinylnaphthalene, derivatives of these, that is, aromaticdivinyl-series-monomers. Among the above-listed, the following substances are more preferable due to less influence to biogeocenosis when the composite according to the invention are used in seas and rivers, etc. The substances include metaacrylicacidester series cross-linker such as ethyleneglycoldi(meta)acrylate, diethylene glycoldi(meta)acrylate, triethylene glycoldi(meta)acrylate, 1,3-butyleneglycoldi(meta)acrylate, 1,4-butanedioldi(meta)acrylate, 1,6-hexanedioldi(meta)acrylate, etc. Caprolactone-modified-dipentaerythritolhexaacrylate, caprolactonemodified-neopentylglycolhydroxypivalatediacrylate, acrylate polyester are also included in the substances.

These crosslinkable monomers can be used independently or combining two or more of these. The use of the crosslinkable monomers improves heat resistance of the polymer particles, then allowing it to select higher temperature conditions of manufacturing the composite and a water-treatment using the composite.

In the invention, the composite includes the water-insoluble organic polymer particles having an adsorption characteristic, a mean diameter of the particles being not limited in particular. However, the diameter and shape of the particles can be adjusted in accordance with a water-treatment process. The mean diameter is preferably 0.2 μm to 5 mm, and more preferably 10 μm to 2 mm. Here, the mean particle diameter is measured with laser diffractometry. Specifically, the diameter can be measured with a SALD-DS21 Laser Diffraction Particle Size Analyzer (trade name) manufactured by Shimadzu Co. Ltd., etc.

The composite also includes the magnetic particles assuming a function for the magnetic collection of the composite after adsorption. Therefore, the particles are not limited particularly only if they are ferromagnetic. As for a magnetic material used for reducing to the magnetic particles, it is preferable to adopt a substance that shows ferromagnetism around at room temperature. However, a practice of the present invention should not be limited to the above-described. In the practice, ferromagnetic substances may be generally used. The substances include, for example, iron, alloys containing iron, magnetite, titanic iron ore, magnetic pyrite, magnesia ferrite, cobalt ferrite, nickel ferrite, barium ferrite, etc. A ferrite series compound among these is chemically stable in water, being effective for the practice of the invention. For example, magnetite (Fe₃O₄) is magnetically stable even underwater and a toxic as a material, being not only cheap but also easy to preferably use for water treatments. Although the magnetic particles can be various, e.g., spherical, polyhedral or irregular in shape, the particle shape is not limited to a specific one of these. What is necessary for using is just to select a preferable particle diameter and a shape of the magnetic particles suitable for manufacturing cost, etc. As for the shape, spherical or polyhedral particles with their corners rounded are preferable. If needed, the magnetic particles may undergo metallizing plating such as Cu-plating and Ni-plating, etc.

In addition, all the magnetic particles do not need to consist of ferromagnetic substances in the invention. That is, the magnetic particles may be very fine to be combined with binders such as polymers. Hydrophobizing treatments may be given to surfaces of the magnetic particles as a surface treatment using alkoxysilane compounds such as methyltrimethoxysilane, methyltriethoxysilane, phenyltrimethoxysilane, phenyltriethoxysilane, etc. As will become apparent below, the composite necessarily includes just magnetic integrant in its body so that the composite are attracted by magnetic forces to be collected in a water-treatment process.

The magnetic particle size may be selected appropriately according to various conditions such as density of the magnetic particles, types and density of a polymer to be used, designed density of the finally obtained composite, etc. in addition to magnetic forces of water-treatment facilities, flow velocities of water, adsorbing methods. However, a mean diameter of the magnetic particles are selected to be normally 0.05-100 μm, and preferably 0.2-5 μm in the invention. Here, the mean diameter is measured in the same way as that for the polymer particles. When the mean diameter is larger than 100 μm, an aggregate formed of the polymer particles and the magnetic particles tends to become too large, having low dispersibility in water. The aggregate also tends to reduce an amount of adsorbed oils due to a decrease in an effective whole surface area of the aggregates of the composite. When diameters of the magnetic particles are smaller than 0.05 μm, the particles tend to clump together densely and to undesirably reduce the surface area of the composite.

The resin binder in the invention allows it to bond the polymer particles and the magnetic particles. Such a resin binder is soluble in a solvent having no influence on the polymer particles and magnetic particles. The binder is not limited in particular, only if the binder allows it to bond the polymer particles and magnetic particles after eliminating the solvent. However, in the invention, after removing oils from water using the composite, contaminants are removed from the polymer particles included in the composite by washing so that the composite can be recycled in some cases. In such a case, it is preferable that the composite are insoluble in washing solvents or oil-extracting solvents. As such a resin binder, a polyvinyl acetal resin is most preferable. Specific usable examples of the polyvinyl acetal resin include a polyvinyl butyral resin, a polyvinyl formal resin, a polyvinyl propanal resin, a polyvinyl hexnal resin, etc. Among these resins, the polyvinyl butyral resin is particularly preferable due to its waterproof and adhesive force. The polyvinyl butyral resin is a polymer which can be obtained by adding butylaldehyde to polyvinyl alcohol under an acid catalyst, and any polyvinyl butyral resin with a different molecular weight can be used for it. Furthermore, it is possible to use copolymeric types with acetic acid vinyl and vinyl alcohol.

As for such a polyvinyl butyral resin, various products are marketed. The products include, for example, S-LEC BL-1, S-LEC BL-1H, S-LEC BL-2, S-LEC BL-5, S-LEC BL-10, S-LEC BL-S, S-LEC BL-SH, S-LEC BX-10, S-LEC BX-L, S-LEC BM-1, S-LEC BM-2, S-LEC BM-5, S-LEC BM-S, S-LEC BM-SH, S-LEC BH-3, S-LEC BH-6, S-LEC BH-S, S-LEC BX-1, S-LEC BX-3, S-LEC BX-5, S-LEC KS-10, S-LEC KS-1, S-LEC KS-3, S-LEC KS-5, etc. (brand name, manufactured by SEKISUI CHEMICAL Co., Ltd.), being selected suitably from the view point of their compatibility with a solvent and adhesive force.

The composite according to the invention may contain various kinds of additives, if needed. For example, oil-absorptive inorganic compounds may be added to the composite in order to enhance oil-adsorbing capabilities. As such oil-absorptive inorganic compounds, fillers of fine silica with a mean particle diameter of 40 nm or less are particularly preferable. The fillers include AEROSIL 130, AEROSIL 200, AEROSIL 200V, AEROSIL 200CF, AEROSIL 200FAD, AEROSIL 300, AEROSIL 300CF, AEROSIL 380, AEROSIL R972, AEROSIL R972V, AEROSIL R972CF, AEROSIL R974, AEROSIL R202, AEROSIL R805, AEROSIL R812, AEROSIL R812S, AEROSIL OX50, AEROSIL TT600, AEROSIL MOX80, AEROSIL MOX170, AEROSIL COK84, AEROSIL RX200, AEROSIL RY200, etc. (brand name, manufactured by NIPPON AEROSIL Co., Ltd.), being oleophilic silica particularly capable of adsorbing oils.

Moreover, fibrous fillers can be also used at the same time. The fibrous fillers include titania, aluminum borate, silicon carbide, silicon nitride, potassium titanate, basic magnesium, zinc oxide, graphite, magnesia, calcium sulfate, magnesium borate, titanium diboride, kinds of whiskers such as alpha-alumina, chrysotile, wollastonite, etc. The fillers also include crystalline fibers such as silicon carbide fiber, zirconia fiber, γ-alumina fiber, α-alumina fiber, PAN-series carbon fiber, PITCH-series carbon fiber, etc. in addition to amorphous fibers such as E-glass fiber, silica-alumina fiber, silica-glass fiber, etc.

The composition according to the present invention is formed of the polymer particles and the magnetic particles, both being bonded with a resin binder. A bonding method of the polymer particles and magnetic particles with the resin binder is not limited particularly. The resin binder is dissolved in a solvent which does not affect the polymer particles and magnetic particles to provide a solution. The polymer particles and magnetic particles are put in the solution, and then mixed. Removing the solvent from the solution yields the bond of the polymer particles and magnetic particles.

More specifically, while revolving the oil-adsorbing polymer particles and magnetic particles in a mixer at high speed, the resin binder is dropped or sprayed into the mixer to uniformly form the oil-adsorbing particle composite. A binder ingredient is preliminarily blended with the magnetic particles to make the binder adhere to surfaces of the magnetic particles. Next, the oil-adsorbing polymer particles are added and mixed to bond the polymer particles and magnetic particles by heating. Furthermore, the magnetic particles, oil-adsorbing polymer particles and resin binder are mixed uniformly to granulate using a three-roll mill, a ball mill, a grinding mixer, a homogenizer, a planetary rotation stirrer, a versatile mixing machine, a push-out machine, a Henschel mixer, etc.

The composite formed through such a manufacturing process possibly contains the polymer particles and magnetic particles which are not bonded. However, it is possible to reduce such isolated particles by adjusting process conditions etc.

### Water-Treatment Method

A water-treatment method according to the invention separates contaminants from water containing the contaminants. Here, the contaminants mean that they are contained in water being supposed to be treated and removed when using the water. Considering sorbability, shape stability, collecting methods after adsorbing, etc. of the oil-adsorbing particle composite according to the invention, it is preferable to apply the composite to a treatment of water containing organic substances, specifically oils. Oils are generally meant by liquids at room temperature, poorly soluble in water, and have comparatively high viscosity and lower specific gravity than water. More specifically, they are animal-and-vegetal oils and fats, hydrocarbons, aromatic oils, etc. These oil-like substances are characterized by their respective functional groups, etc. It is, therefore, preferable to select a polymer which constitutes the composite according to each functional group.

In the water-treatment method according to the invention, the oil-adsorbing particle composite is dispersed in the water containing the above-described contaminants. The composite adsorbs the contaminants due to the affinity between surfaces of the polymer particles contained in the composite and the contaminants. The polymer particles contained in the composite according to the invention have a nonsmooth surface, the surface being porous. Thus, the polymer particles have a relatively large surface area. This aspect provides the composite with a high efficiency for adsorbing the contaminants. The adsorption rate of the composite according to the invention is basically very high although it depends also on the contaminant concentration or an additive amount of the composite to be dispersed in the water. When a sufficient amount of the composite is put in the water, generally more than 80%, preferably more than 97%, more preferably more than 98% and most preferably 99% of the impurities are adsorbed onto the surface of the polymer particles of the composite.

After the composite adsorbs the contaminants in the water onto its surface, the composite is separated from the water, the contaminants being removed from the water as a result. Here, magnetic forces are used to separate the composite from the water. That is, the magnetic particles and the polymer particles are bonded to form the composite, thus the composite being entirely attracted by a magnet. This results in an easy collection of the composite. It is also possible to use sedimentation by gravitational force and a centrifugal separation by a cyclone separator combined with the separation by the magnetic force. The combined use of the above methods improves the workability and allows it to collect the composite rapidly.

Water targeted by the water treatment is not limited particularly. Specifically, the water treatment can be applied to industrial wastewater, sewage water, human sewage, etc. A contaminant concentration of the targeted water is not limited particularly. When the contaminant concentration is extremely high, a large amount of the composite is needed. Therefore, it is more efficient to firstly attenuate the water by another method followed by the water treatment of the attenuated water.

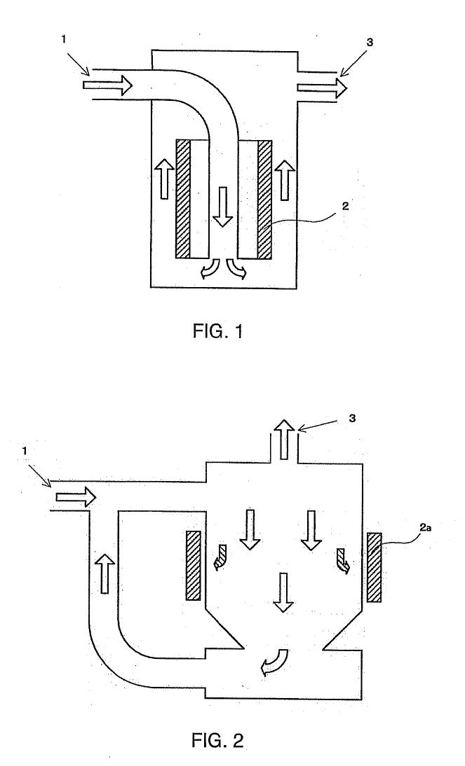

An apparatus to practice the method for the water treatment according to the invention is exemplified in FIGS. 1 and 2. FIG. 1 shows a comparatively small apparatus, preferably applied to a small-scale household water-treatment with a low flow rate. The wastewater introduced from a drain inlet 1 is passed through a pipe with a magnet 2 arranged around and discharged from a drain outlet 3. The composite according to the invention is mixed to the wastewater before being introduced from the drain inlet 1. Oils in the wastewater are adsorbed by the oil-adsorbing polymer particles contained in the composite. The particles having adsorbed the oils accumulate inside the pipe with the magnet 2 arranged around to be finally collected.

The apparatus shown in FIG. 2 is suitable for treating a large volume of water in factories or stranded tanker outpouring oils in a sea. The composite according to the invention is mixed to the wastewater before being introduced from the drain inlet 1 in FIG. 2 as well as in FIG. 1. After having adsorbed oils in the water, the composite is collected using a superconducting magnet 2a, thus being removed from the water. The water thus treated is ejected from the drain outlet 3.

The apparatuses fix the composite with the magnetic particles to the magnet, adsorbing and removing the underwater oils as a result. Its water-treatment capability is improved by arranging a net-shaped magnet inside the pipe to magnetically fix the composite to the magnet.

In order to collect oils finally, the composite that has already adsorbed oils is taken out from the pipe or the tank. Then, the composite is washed with an oil-extracting solvent or an oil-washing solvent such as n-hexane and alcohol to disconnect the oils from the composite. Thus, the composite may be recycled. These apparatuses are fixedly placed. In addition, they may be mounted on an oil-treating boat as a mobile type.

The composite is collected after the water treatment to be reproduced for recycling. In order to reproduce the composite, the adsorbed contaminants are required to be removed from the composite. Thus, it is preferable to wash the composite with a solvent. In this case, washing solvents or oil-extracting solvents used preferably do not dissolve the polymer particles and resin binder in the composite, but may dissolve the adsorbed contaminants. The solvents include methanol, ethanol, n-propanol, isopropanol, acetone, tetrahydrofuran, n-hexane, cyclohexane, and a mixture of these. Moreover, even solvents other than the above-listed may be used according to kinds of contaminants and polymers.

### EXAMPLES 1 TO 8

Granular ferrite (ferrite particles) with a mean diameter of 0.79 μm and saturation magnetization of 84.4 emu/g was mixed with an oil-adsorbing polymer for 30 sec using a mixer with a rotating velocity of 12600 rpm to obtain examples 1 to 8 shown in TABLE 1A. Subsequently, a resin solution with a concentration of 12% by weight, which dissolved a butyral resin in cyclohexanone, was prepared to deliver the solution by drops into the granular ferrite and oil-adsorbing polymer, being further mixed under the same condition as that described above. Then, the oil-adsorbing polymer, granular ferrite and binder were added by 40 wt % (% by weight), 40 wt % and 20 wt %, respectively, to blend. Furthermore, granulating the blended using a ball mill was followed by drying at 50° C. for 15 hours to provide the oil-adsorbing particle composite.

### COMPARATIVE EXAMPLES 1 TO 3

Granular styrene-butadiene copolymers with mean diameters of 200, 780 and 920 μm were prepared as oil-adsorbing particles of comparative examples 1, 2 and 3, respectively, shown in TABLE 1B. The granular polymer is normally used as an oil-gelatinizing agent. These were evaluated as they were.

TABLE 1A

| | | MEAN |
|---|---|---|
| | | PARTICLE |
| | | DIAMETER |
| | POLYMER | (μm) |
| EXAMPLE 1 | styrene butadiene copolymer | 200 |
| EXAMPLE 2 | styrene butadiene copolymer | 500 |
| EXAMPLE 3 | styrene butadiene isopropylene | 700 |
| EXAMPLE 4 | hydrogenated styrene isoprene butadiene | 500 |
| | copolymer | |
| EXAMPLE 5 | methyl methacrylate butadiene styrene | 120 |
| EXAMPLE 6 | methyl methacrylate butadiene styrene | 6.91 |
| EXAMPLE 7 | methyl methacrylate ethylene glycol | 7.96 |
| | dimethacrylate copolymer | |
| EXAMPLE 8 | cross-linked alkyl acrylate polymer | 8.3 |

TABLE 1B

| | | MEAN |
|---|---|---|
| | | PARTICLE |
| | | DIAMETER |
| | GELLING AGENT | (μm) |
| EXAMPLE 1 | styrene butadiene copolymer | 200 |
| EXAMPLE 2 | styrene butadiene copolymer | 780 |
| EXAMPLE 3 | styrene butadiene copolymer | 920 |

### Evaluation of Oil-Adsorbing Particle Composite

The following items were evaluated for the composites of the examples 1 to 8 and the granular polymer of the comparative examples 1 to 3.

### (1) Evaluation of Oil-Adsorbing Capability:

A prescribed mineral oil was added to 20 mL of purified water, 0.1 g of the composite being further added. The oil and composite were mixed uniformly using a shaker. The removal of the composite was followed by an extraction of a residual oil with an alternative-for-fluorocarbon solvent H-997 (brand name: manufactured by HORIBA MANUFACTURING Co., LTD.). The extracted amount of the residual oil in the aftertreatment water was measured with an oil content monitor OCMA-305 (brand name: manufactured by HORIBA MANUFACTURING Co., LTD.).

### (2) Mean Particle Diameter:

The oil adsorbing particles of the composite were observed using an electron microscope. The mean particle diameter was measured by deriving the mean diameter of the particles on an arbitrary straight line drawn (for example, on a diagonal line) on an electron micrograph.

### (3) Status of the Particles Adsorbing Oil:

The status of the oil-adsorbing particles of the composite was observed visually after homogeneously mixing of the oil and composite in (1).

### (4) Resistance to an Oil Extracting Solvent:

When extracting with an oil extracting solvent in (1), the status of the oil-adsorbing particles was observed visually after being immersed in the solvent.

### (5) Collection of Oil-Adsorbing Particles With a Magnet:

It was visually observed to able to collect the oil-adsorbing particles or not with a magnet after the particles adsorbed the mineral oil.

TABLE 2

| | ADDITIVE AMOUNT OF OIL (μl) | | | | | | | | | | |
|---|---|---|---|---|---|---|---|---|---|---|---|
| | 20 | 30 | 40 | 50 | 60 | 70 | 80 | 90 | 100 | 110 | 120 |
| EXAMPLE 1 | 3 | 2 | 2 | 4 | 4 | 5 | 14 | 20 | 45 | 350 | 540 |
| EXAMPLE 2 | 2 | 3 | 6 | 2 | 5 | 5 | 15 | 24 | 380 | 320 | 450 |
| EXAMPLE 3 | 2 | 5 | 5 | 8 | 4 | 13 | 12 | 40 | 129 | 251 | 260 |
| EXAMPLE 4 | 1 | 1 | 4 | 2 | 4 | 4 | 4 | 5 | 6 | 8 | 12 |
| EXAMPLE 5 | 2 | 4 | 5 | 2 | 5 | 2 | 3 | 4 | 3 | 21 | 20 |
| EXAMPLE 6 | 2 | 1 | 4 | 8 | 3 | 4 | 2 | 4 | 5 | 24 | 26 |
| EXAMPLE 7 | 1 | 5 | 6 | 3 | 5 | 5 | 5 | 5 | 10 | 7 | 14 |
| EXAMPLE 8 | 2 | 3 | 7 | 4 | 3 | 6 | 7 | 5 | 14 | 23 | 30 |
| COMPARATIVE | 5 | 7 | 4 | 10 | 5 | 51 | 154 | 830 | 1208 | 2400 | 1640 |
| EXAMPLE 1 | | | | | | | | | | | |
| COMPARATIVE | 1 | 4 | 2 | 8 | 6 | 161 | 162 | 740 | 1008 | 1508 | 2400 |
| EXAMPLE 2 | | | | | | | | | | | |
| COMPARATIVE | 4 | 6 | 5 | 9 | 3 | 165 | 172 | 854 | 1230 | 1640 | 2140 |
| EXAMPLE 3 | | | | | | | | | | | |

Unit: mg/liter

TABLE 3

| | MEAN | | | |
|---|---|---|---|---|
| | PARTICLE | STATUS OF | RESISTANCE TO OIL- | COLLECTION WITH |
| | DIAMETER | THE | EXTRACTING | MAGNET AFTER |
| | (μm) | COMPOSITE | SOLVENT | ADSORPTION |
| EXAMPLE 1 | 240 | GOOD | NO CHANGE | GOOD |
| EXAMPLE 2 | 560 | GOOD | NO CHANGE | GOOD |
| EXAMPLE 3 | 780 | GOOD | NO CHANGE | GOOD |
| EXAMPLE 4 | 530 | GOOD | NO CHANGE | GOOD |
| EXAMPLE 5 | 154 | GOOD | NO CHANGE | GOOD |
| EXAMPLE 6 | 31 | GOOD | NO CHANGE | GOOD |
| EXAMPLE 7 | 18 | GOOD | NO CHANGE | GOOD |
| EXAMPLE 8 | 25 | GOOD | NO CHANGE | GOOD |
| COMPARATIVE | 200 | NG(*) | SWELLHEADED | IMPOSSIBLE |
| EXAMPLE 1 | | | | |
| COMPARATIVE | 780 | NG(*) | SWELLHEADED | IMPOSSIBLE |
| EXAMPLE 1 | | | | |
| COMPARATIVE | 920 | NG(*) | SWELLHEADED | IMPOSSIBLE |
| EXAMPLE 1 | | | | |

(*)Large clumps

What is claimed is:

1. An oil-adsorbing particle composite for a water treatment comprising water-insoluble organic polymer particles, magnetic particles and a resin binder, the resin binder bonding the polymer particles and the magnetic particles.

2. The composite according to claim 1, wherein the water-insoluble organic polymer particles include at least one of homopolymers and copolymers, the homopolymers and the copolymers being synthesized at least from one kind of monomer, the monomer being selected from monomers with a polymerizable unsaturated bond.

3. The composite according to claim 1, wherein the water-insoluble organic polymer particles are porous in structure.

4. The composite according to claim 2, wherein the water-insoluble organic polymer particles are porous in structure.

5. The composite according to claim 1, wherein a mean diameter of the water-insoluble organic polymer particles is not less than 0.2 μm and not more than 5 mm.

6. The composite according to claim 1, wherein the resin binder is a polyvinyl acetal resin.

7. The composite according to claim 1, wherein a mean diameter of the magnetic particles is not less than 0.05 and not more than 100 μm.

8. The composite according to claim 2, wherein a mean diameter of the magnetic particles is not less than 0.05 and not more than 100 μm.

9. The composite according to claim 3, wherein a mean diameter of the magnetic particles is not less than 0.05 and not more than 100 μm.

10. The composite according to claim 4, wherein a mean diameter of the magnetic particles is not less than 0.05 and not more than 100 μm.

11. The composite according to claim 5, wherein a mean diameter of the magnetic particles is not less than 0.05 and not more than 100 μm.

12. The composite according to claim 6, wherein a mean diameter of the magnetic particles is not less than 0.05 and not more than 100 μm.

13 A water-treatment method comprising:
dispersing the composite in water containing contaminants;
making the polymer particles adsorb the contaminants; and
separating the polymer particles from the water after the adsorbing.

14. A method for regenerating the composite used for the water treatment, comprising the step of washing the composite with a solvent selected from methanol, ethanol, n-propanol, isopropanol, acetone, tetrahydrofuran, n-hexane, cyclohexane.
